(19) United States
(12) Patent Application Publication
(10) Pub. No.: US 2014/0370956 A1
(43) Pub. Date: Dec. 18, 2014

(54) Interactive Online Lottery Game

(71) Applicant: Donald J. FIECHTER, Cumming, GA (US)

(72) Inventor: Donald J. FIECHTER, Cumming, GA (US)

(21) Appl. No.: 13/918,299

(22) Filed: Jun. 14, 2013

(51) Int. Cl. G07F 17/32

(52) U.S. Cl. CPC G07F 17/329
USPC 463/17

(57) ABSTRACT

The present invention provides an interactive online lottery game for poker, bingo or other type of multiplayer online game. The player may buy a ticket in a retail store or other similar location and play against other players online. The ticket comprises an Internet access code and preferably a website address providing the game. The players or the operator may pre-establish the amount of dollars to spend during a game.

### CROSS-REFERENCE TO RELATED APPLICATIONS

The present patent application is a continuation in part of U.S. patent application Ser. No. 12/866,344 entitled “Interactive Online Lottery Game” which is the national stage of International Application Number PCT/IB2009/005028 entitled “Interactive Online Lottery Game” which claims the benefits of priority of commonly assigned Canadian Patent Application No. 2,619,555, entitled “Interactive Online Lottery Game” and filed at the Canadian Intellectual Property Office on Feb. 5, 2008.

### FIELD OF THE INVENTION

The present invention generally relates to lottery games, more particularly to an interactive game that may be played online with other players.

### BACKGROUND OF THE INVENTION

Currently, a wide variety of lottery games, entertainment options and gaming systems are available. To date though, there have been specific obstacles to implementing lottery and interactive play via the Internet. However, the Internet is extremely effective, efficient and economic in providing limitless access.

An obstacle to the utilization of the Internet to distribute lottery products is the issue of age control. Unless lotteries can provide mechanisms and procedures to prevent play by minors, internet access for lottery games is not likely to be implemented. Use of credit cards may permit under age players to play unless some other means of age verification is available.

Another paramount concern in the implementation of internet access to lottery products is one of jurisdictional control. States typically have a monopoly to provide their lottery products to players within their geographic area. In general, lottery authority officials restrict the sale of their products within their jurisdiction, and have resisted opportunities to market their products outside their jurisdiction.

The use of the Internet can provide access to players outside of a particular jurisdiction, even with controlled access.

As such, there is a need for an improved, more exciting lottery game that utilizes the Internet or other communication network while still providing the lottery authority with age control and jurisdictional control. Furthermore, there is a need to find a way to increase lottery participation by people who typically do not play lottery or fit the traditional demographics of a lottery player.

### OBJECTS OF THE INVENTION

A first object of the present invention is to provide a lottery game that may be played online by a plurality of players.

A second object of the present invention is to provide an online lottery game based on poker, bingo or other multiplayer games such as in casino games where at least one winning player is awarded the total amount bet by at least two real players less the lottery authority fees and costs (herein collectively referred to as the lottery authority fees).

Another object of the invention is to provide an online lottery game which is played under the control and safety of a state run lottery.

Still another object of the invention is to solve the issues that states would have in allowing online play by handing over its operation to the state run lottery.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The aforesaid and other objectives of the present invention are realized by generally providing a method to play to an interactive online lottery game allowing a first player to play online against at least one other participating player and wherein the first player bets an amount of money, the game being played on a computerized device, the method comprising the steps of providing a lottery ticket comprising an Internet access code, the lottery ticket being purchased by the first player for a predetermined price; providing an online interface allowing the first player to play against the other players; asking the player to enter the Internet access code into the interface; and wherein at least one winning player is awarded the total amount bet by the participating players less the lottery authority fees.

In another embodiment, the present invention provides a terminal allowing a first player to play to an interactive online lottery game against at least one other player and wherein the first players bets an amounts of money, the terminal comprising means to provide a lottery ticket comprising an Internet access code, the lottery ticket being purchased by the first player for a predetermined price, an online interface allowing the first player to play against the other participating players, means to interact with the first player, and means allowing one of the first player and the other players to redeem a prize.

In another embodiment, the present invention provides a lottery ticket allowing a first player to play to an interactive online lottery game against at least one other player and wherein the first player and the other players bet amounts of money, the game being played on a computerized device, the lottery ticket comprising an Internet access code, the access code allowing the user first player to participate to the game.

In a still further embodiment, the present invention provides a method to play an interactive multiplayer online lottery game such as poker or bingo allowing players to play online against other players on a computerized device, the method comprising the step of providing a lottery ticket comprising an Internet access code and a website address to play to said game, creating an account online for the player, asking the player to pre-establish the amount of dollars to spend during the game and asking the player to enter the Internet access code to begin the game.

With the use of this invention, a given lottery authority is able to organize game tournaments open to players within the state who meet the legal requirements for participation in a lottery. The game is typically a multiplayer game.

The invention addresses the need to maintain jurisdictional and age control in the sale of lottery tickets. The ticket being sold in a physical location, such as a convenience store or other similar location, it is possible to control the age of the persons who want to buy a lottery ticket in the same way that alcohol is usually regulated regarding the age of the buyers.

In United States, the lottery regulations may differ from one state to another thus the player will have to purchase the lottery ticket within the state who is offering the tournament. Also, in order for a player to collect his/her prize he/she would have to pick it up within the state where the ticket was purchased.

This invention uses the Internet or other similar networks which is appealing to the new generation of lottery players, those who have been brought up with a mouse (or joy stick) in their hand. This next generation of computer savvy players is looking for the thrill and entertainment value offered by interactive games. Furthermore, the present invention promotes the use of a live game event. Indeed, players participate to a real poker, bingo or other multiplayer games such as in casino and preferably play against real players.

In a further embodiment, the sequence of events or steps for an operator conducting an online game tournament, according to the present invention, in which participants compete against each other by playing over a communications network may comprises one or more of the following:
a plurality of remote players who participate in a tournament comparing scores, accumulating points, chip counts, spots matched or rankings;
each remote player must establish an account and provide an initial monetary purchase at lottery retail establishments;
registering each player for the tournament based on purchase level made at lottery retailer;
each player may also be ranked at some point by player experience, player rank and player winnings;
limiting the number of remote players that can participate in a tournament to a specific number;
limiting the number of players that can participate in the tournament by establishing maximum seats to be sold through lottery retailers;
enabling additional players to participate in an additional tournaments when the tournaments have been filled with the specific number of players;
award a prize to the winner of the tournament.

The player purchases a ticket for the game in a lottery retail location. The ticket comprises an Internet access code and preferably an Internet address for interactive Internet-based play. In a preferred embodiment, the ticket reserves a “seat” or a participation to an online game at a time chosen by the player among the available times. The ticket has an Internet access code allowing the player to enter into a game. For example, it may be a two part serial number representing the “seat” at the particular tournament chosen at purchase but it is not limited to this type of identification. The interactive game may be played from one's own personal computer or an online terminal. The game may be played on any computerized device having an Internet connection.

In a preferred embodiment, to play the game, the player opens an account on the web site indicated on the ticket. At the point of account creation the player is asked to establish a limit to the amount of dollars he would like to limit himself to spend on a given online lottery game tournament up to a maximum established by the appropriate lottery authority. In a further embodiment, it would be possible to control the identity of players in order to set an individual maximum amount of dollar to be spent in a determined period of time to prevent compulsive players to spend over said individual maximum amount of dollars. Once the account is open, the player then enters the lottery game lobby. The player selects the tournament and enters the Internet access code of the ticket. From the lobby, the player is able to view the tournament time that he/she purchased his ticket. Player is informed that they are entered into that tournament and will be given a “seat” once the tournament begins.

In another embodiment, the player may register his account through lottery retail establishments. The entity receiving identification information from a player to create his account may determine whether the identification information received is valid prior to create or to validate the account.

In a still further embodiment, to validate the creation of the account, online or in a retailer store, the operator would have to obtain the player authorization. If the authorization is obtained the player account is then registered and the player purchase could be directly transferred into the player account thus the amount of dollar to play would be already available when the player logs on to play a game. As an incentive to bring other persons to play the online lottery game there could be the free remittance or credit of an amount of money to play from a sponsor from whom the other persons are likely to buy some goods or services.

In another embodiment, the player may enter the lottery game lobby at any time he/she wishes during the pre-determined period of validity of his ticket. Then he/she may select any “seat” that is available and begin to play as soon as a pre-determined minimum number of “seats” are taken.

The tournaments offered could be of varying monetary amounts and this could allow a player to play a game and still control the amount that will be spent. Two ways are possible to choose the amount to spend. The first as described above and the second is by buying a ticket corresponding to the maximum amount to be played. For example, the player may buy among a selection of tickets corresponding to the amount (for example $5, $10, etc. . . . ) to be spent.

The data related to the players, such as his/her name or address for example, may be saved on a server. Furthermore, if the player has not spent all his predetermined amount of money during a game, this information can be saved and the player will have a remaining amount to play with the next time he will participate to another game.

In another aspect, to control the amount of money to be spent, it could be possible to predetermine the available amounts depending of the player. The criteria to determine said amount of dollar may be individual characteristics, a membership or an adherence to a group. This could promote some players to join a group of particular sponsors in order to have access to a supplemental amount to play. The supplemental amount can be bought by the player when he/she buys a ticket and shows a membership proof. It could also be possible to give a free bonus amount to play to a player if he/she joins a group of a particular sponsor of the online lottery game.

For example, a maximum amount may be determined for the groups of players between 18 and 21 years old. If a player has a history of gambling, a maximum amount may be predetermined for each game and for a period or even be blocked from playing online

It could also be possible to fix a maximum amount of money to be spent during a period. For example, a player may be limited to play a maximum of 200 dollars in a month for a particular lottery game as described in the present invention. If different lottery games are available following the present invention, the maximum amount of dollars to be spent may be determined for each game or for all the lottery games.

In another aspect, a player could be allowed to buy a lottery ticket online instead of in a retail store. In such instance the player would preferably need to have his age or other eligibility requirement validated by an authorized person or entity, an operator of the lottery game, that would provide an access code allowing the player to purchase his/her ticket(s) online In still another aspect, a terminal specially conceived to this kind of online lottery game may be provided at some sale points and the player could buy a lottery ticket through this terminal.

Sponsors can post publicity on the website during a game. It could be possible for a sponsor to provide a bonus for a game. The bonus may be money, a coupon exchangeable for their products or a particular product.

The online lottery game of the present invention can be a part of many types of events. Another example is the organization of a special game where the amounts played will be distributed to one or more charities.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a flow chart of one embodiment of the lottery gaming system and associated method according to this invention.

FIG. 2 is a flow chart of a second embodiment of the lottery gaming system and associated method according to this invention.

FIG. 3 is a schematic representation of a lottery gaming system according to presently preferred embodiments of this invention.

### DETAILED DESCRIPTION OF THE PREFERRED EMBODIMENT

A novel interactive multiplayer online lottery game will be described hereinafter. Although the invention is described in terms of specific illustrative embodiment(s), it is to be understood that the embodiment(s) described herein are by way of example only and that the scope of the invention is not intended to be limited thereby.

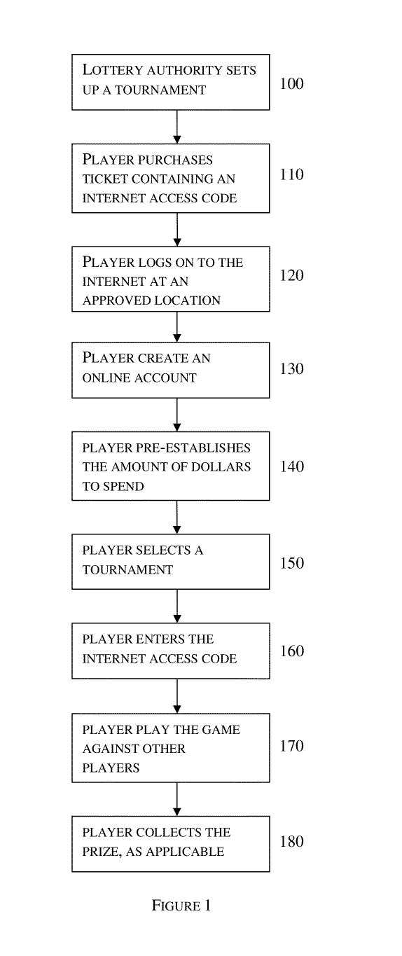

Referring to FIG. 1, a flow chart of an embodiment of the interactive online lottery game according to this invention is shown. The applicable lottery authority sets up one or more Internet tournaments 100. The lottery game is initiated by a player purchasing a ticket 110 at a retail location that is authorized by the applicable lottery authority to sell such ticket. The step of age control may be carried out at the time the ticket is purchased. The ticket comprises at least an Internet access code and preferably a website address. Then, from any known computerized devices 120, the player accesses the website preferably indicated on the ticket and creates an account 130. The player is asked to pre-establish an amount of dollar that will be spent 140 during the game up to the maximum allowed by the lottery authority. The amount may vary but is typically relatively small to be accessible to the majority of people, similarly to typical lottery tickets.

On the website, the player selects the appropriate tournament 150 and he/she is asked to enter the Internet access code indicated on the ticket 160. Afterward the player is brought to a web page schematically displaying a game table or its representation and the game begins 170. The objective of the game is to beat the others players participating at the same game as opponents. These opponents can be actual players or computer generated players or computer simulation. The winner of the game can further collect the prize 180 by presentation of the original ticket at any lottery retailer, by submitting a form over the Internet, or having the money deposited for future use in particular store or web site of a sponsor. In a preferred embodiment, prize 180 which is awarded the winning player is the total amount bet by all the participating players less the lottery authority fees. It could also be possible to win a product or a service, for example a TV, a camera or a subscription to a magazine or other publication for a predetermined amount of time.

Importantly, the purchase of the initial ticket 110 from an approved retailer provides safeguards and controls with respect to play by minors. Purchasing the original ticket at an authorized lottery retailer eliminates the issue of jurisdiction control while allowing the player access to the game via the Internet, for example, even if the player resides in a different jurisdiction from where the ticket was purchased.

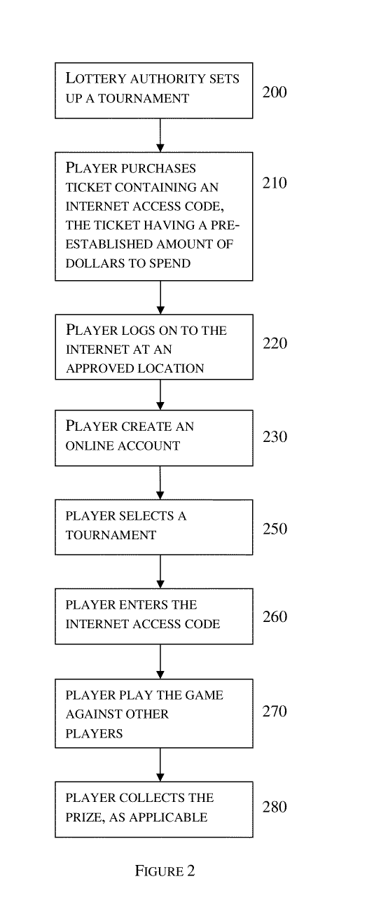

Referring now to FIG. 2, a flow chart of another embodiment of the interactive online lottery poker game according to this invention is shown. In this embodiment a lottery authority typically sets up a tournament or a game 200 wherein there generally is a predetermined amount of money to win. In this embodiment, the player purchases 210 a ticket which has a pre-determined amount to spend during the game instead of choosing the amount of dollars to spend by himself.

Similarly to the embodiment of FIG. 1, after having bought a ticket, the player will reach the website providing the online lottery game 220. The player is asked to create an account 230 and provides information such as his/her name, his/her address and/or other information. This step provides the advantage of allowing a future verification regarding the identity and the age of the player, for example. After this step, the player may enter a game or a tournament 250 and he/she is prompted to enter his/her internet access code 260. The player may then plays to the game against the other players 270 (real and/or computer generated). When the game is finished, the player who won may collect his/her prize 280 at a lottery retailer or at a particular store of a sponsor.

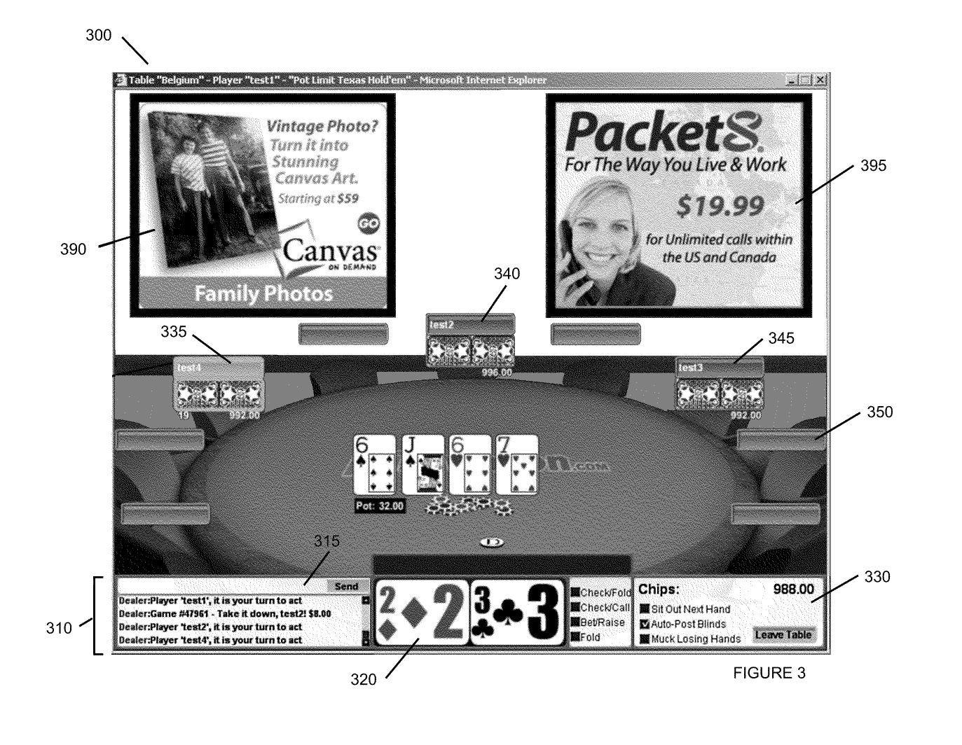

FIG. 3 shows an embodiment of the lottery poker lobby as displayed on a web page of a computerized device. This embodiment is described for a Texan Hold'Em type poker game but it may be another type of poker or other similar multiplayer game. At the bottom of the screen 300, there is a menu 310 comprising information for the player. In the menu 310, the player sees the instruction box 315, the card box 320, the gaming or action box 325, and the chip box 330. The latter boxes allow the player to what he wants to do when it is his/her turn to play by cliquing in the appropriate box.

The player boxes 335, 340 and 345 represent each player at a particular “seat”. The player box 350 represents an empty “seat”. In each player box, the name or alias of the player is indicated in the upper portion of the player box, as well as the current bet 360 and the residual amount of money 355. The table further comprises the amount of the “pot” 375 on the table and the community cards 370.

Sponsors may post publicity on the website during the game, such as images 390 and 395. The publicity may take the form of a text, a picture or a video.

The prize for a game may be unique when the game is allowing only one player to win. For example, in a poker game, only one player will get the pot because he got the better hand. In the case wherein only one player wins the prize, the winning player is awarded the total amount bet by at least two participating players less lottery authority fees. Otherwise, the prize or gain for a single player may be the amount of dollars he gained during the game. In a game such as Black Jack, each player may win during each hand. In multiple winner cases, the at least two winning players are awarded the total amount bet by at least two players less lottery authority fees.

It is to be understood that the content of the web page shown in the embodiment of FIG. 3 relates to one type of poker. The content of the web page will evidently be different for other casino games. The content of the web page may be displayed differently, and supplemental or less content may be modified without departing from the present invention.

The online lottery game of the present invention may be played on any device having an online connection such as computers, phone, PDA or even be played on television with an appropriate service.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A method to play an interactive online lottery game, the method comprising:
a. retrieving a lottery ticket from a sales terminal, the lottery ticket having a unique Internet access code to which is associated an amount of money, the access code being generated by a server operated by a lottery authority, the sales terminal being in communication with the server;
b. inputting the access code in a gaming interface on a computerized device to gain access to the online lottery game;
c. playing the lottery game on the computerized device;
wherein the lottery game involves at least two real players playing against each other, wherein each player can bet the amount of money initially associated with the access code; wherein at least one winning player is awarded the total amount bet by the at least two real players less the lottery authority fees; and, wherein the outcome of the game is determined by the actions of the players.

2. A method to play an interactive online lottery game as described in claim 1, further comprising awarding a prize to a player of the game, wherein the awarded player is determined according to the rules of the game and wherein the prize is associated with the access code.

3. A method to play an interactive online lottery game as described in claim 2, wherein the amount of money bet by a player is deduced from the amount of money associated with the access code.

4. A method to play an interactive online lottery game as described in claim 2, further comprising retrieving a price at an authorized lottery retailer.

5. A method to play an interactive online lottery game as described in claim 3, further comprising creating an online account for a player.

6. A method to play an interactive online lottery game as described in claim 3, wherein the amount of money initially associated with the access code is predetermined by the lottery authority.

7. A method to play an interactive online lottery game as described in claim 6, wherein the predetermined amount of money corresponds to the price of the ticket.

8. A method to play an interactive online lottery game as described in claim 7, wherein the computerized device is comprised in a terminal.

9. A method to play an interactive online lottery game as described in claim 8, wherein the prize is relative to the amount of money bet by the players.

10. A method to play an interactive online lottery game as described in claim 8, wherein the prize is predetermined by the lottery authority.

11. A method to play an interactive online lottery game as described in claim 3, wherein the amount of money bet is inputted by the at least two players into the gaming interface.

12. A method to play an interactive online lottery game as described in claim 3, further comprising saving the remaining amount of money associated with the access code when a player stops playing into an online account for an online game.

13. A method to play an interactive online lottery game as described in claim 3, further comprising the step of displaying publicity of sponsors within the gaming interface.

14. A terminal to play an online lottery game, the terminal being connected to a server accessible through a network comprising:
a. a device configured to provide a lottery ticket comprising a unique Internet access code, wherein an amount of money is associated to the unique Internet, the access code being generated by a server operated by a lottery authority, the sales terminal being in communication with the server
b. an online interface allowing the first player to play against the other players;
c. an interface to interact with the first player; and
d. means allowing one of the first player and other real players to redeem a prize;
wherein a first player to play to an interactive online lottery game against at least one other real player and wherein the first player bets an amount of money, wherein the lottery ticket is being purchased by the first player for a predetermined price, wherein at least one winning player is awarded the total amount bet by the at least two real players less the lottery authority fees; and wherein the terminal is connected to a server accessible through a network.

15. A terminal to play an online lottery game as described in claim 14, wherein the ticket is bought for a predetermined amount of money; wherein the Internet access code allows the players to have access to the online lottery game; wherein the player plays against other real players; and wherein the outcome of the game is determined by the actions of the players.

16. A terminal to play an online lottery game as described in claim 15, wherein the amount bet by each player corresponds to at least a part of the predetermined amount.

17. A terminal to play an online lottery game as described in claim 16, wherein only one of the players is awarded a prize and wherein the awarded player is determined according to the rules of the game.

18. A terminal to play an online lottery game as described in claim 17, wherein the awarded prize corresponds to the amount of money bet by the players.

19. A terminal to play an online lottery game as described in claim 18, wherein the Internet access code is associated with the prize and wherein the awarded prize is redeemed by the winning player at an authorized lottery retailer.

20. A lottery ticket allowing a first player to play an online game against at least one other real player, the ticket comprising a unique Internet access code to which is associated an amount of money, the Internet access code being generated by a server operated by a lottery authority, the sales terminal being in communication with the server;
wherein a player can bet the amount of money initially associated with the Internet access code wherein the game is played on a computerized device;
wherein the ticket is issued through a sales terminal operatively connected to the server and the ticket is bought for a predetermined amount of money;
wherein the Internet access code allows a player to gain access to the online game by being inputted in the computerized device;
wherein the outcome of the game is determined by the actions of the players;
wherein at least one winning player is awarded the total amount bet by the at least two real players less the lottery authority fees;
wherein a winner is determined according to the rules of the game and among the players.

21. A lottery ticket as claimed in claim 20, wherein the amount of money bet by each player correspond to a part of the predetermined amount of money;

22. A lottery ticket as described in claim 21, wherein the lottery tickets allows only one player to be awarded a prize, the awarded prize being proportional to the amount bet by the players and the awarded prize being redeemed by the awarded player at an authorized lottery retailer.
